(19) United States
(12) Patent Application Publication
(10) Pub. No.: US 2026/0298833 A1
(43) Pub. Date: Oct. 1, 2026

(54) ELECTRIC MOTOR STATOR END-TURN WINDINGS COATING DEFECT DETECTION

(71) Applicant: GM GLOBAL TECHNOLOGY OPERATIONS LLC, Detroit, MI (US)

(72) Inventors: Ronald Buchholz, Casco, MI (US); John D. Campbell, Rochester Hills, MI (US); Adrian Sinishtaj, Shelby Township, MI (US)

(73) Assignee: GM GLOBAL TECHNOLOGY OPERATIONS LLC, Detroit, MI (US)

(21) Appl. No.: 19/089,319

(22) Filed: Mar. 25, 2025

(51) Int. Cl. G01N 21/88; H02K 15/122

(52) U.S. Cl. CPC G01N 21/8806; G01N 21/8851; H02K 15/122

(57) ABSTRACT

A method of detecting coating defects on electric motor stator windings includes providing the stator assembly via an automated assembly line. The method also includes heating exposed end-turns of stator windings via a heating arrangement and coating the exposed heated end-turns with epoxy. The method additionally includes turning the stator assembly with coated heated end-turns relative to a stator axis via a rotating arrangement. The method also includes applying thermal imaging, via an imaging device in operative communication with an electronic controller, to the coated heated end-turns of the turning stator assembly. The method further includes identifying, via the controller, a flaw in coverage of the insulating medium on the coated end-turns using the applied thermal imaging and commanding a rejection of the stator assembly having the identified flaw.

### INTRODUCTION

The disclosure relates to inspection for and detection of coating defects on stator windings of an electric motor.

An electric motor is a machine that converts electric energy into mechanical energy. Electric motors may be configured as an alternating current (AC) or a direct current (DC) type. An electric motor’s operation is based on an electromagnetic interaction between permanent magnets and the magnetic field created by the machine’s selectively energized coils. Electric motors are classified into two categories based on the direction of the magnetic field – axial flux motors and radial flux motors. Generally, axial flux motors include rotors internal to the corresponding stators, while radial flux motors include rotors positioned alongside the stators.

Axial flux motors may be synchronous or asynchronous (a.k.a. induction motors) and generally include two main components – rotor and stator. The rotor includes permanent magnets and rotates inside the stator. The stator includes wire windings or coils wrapped around a stator core and selectively energized via supplied current to induce a magnetic field that penetrates the rotor and generates motor torque. To optimize the distribution of the magnetic field, wire windings are typically arranged in slots around the stator, with the magnetic field having the same number of north and south poles. Individual wire windings are generally isolated from each other using a coating to preclude an electrical short circuit during operation of the electric motor.

### SUMMARY

A method of detecting coating defects or flaws on windings of a stator assembly for an electric motor includes providing, via an automated assembly line, the stator assembly having a plurality of stator windings with exposed end-turns arranged around a stator axis. The method also includes heating the exposed end-turns of the stator windings via a heating arrangement and coating the exposed heated end-turns of the stator windings with an insulating medium. The method additionally includes turning the stator assembly with the coated heated end-turns relative to the stator axis via a rotating arrangement. The method also includes applying thermal imaging, via an imaging device in operative communication with an electronic controller, to the coated heated end-turns of the turning heated stator assembly. The method additionally includes identifying, via the electronic controller, a flaw in coverage of the insulating medium on the coated end-turns using the applied thermal imaging. The method further includes commanding, via the electronic controller, a rejection of the stator assembly having the identified flaw in coverage of the insulating medium on the corresponding coated end-turns.

Applying thermal imaging may include the use of an infrared camera.

The infrared camera may be arranged at a predefined angle, such as in a range of 10-30 degrees, relative to the stator axis.

The electronic controller may be programmed with an artificial intelligence (AI) algorithm configured to identify the flaw in coverage of the insulating medium on the end-turns.

The AI algorithm may be configured to use image processing to recognize flaws in coverage of the insulating medium on the end-turns.

The AI algorithm may be trained to recognize flaws in coverage of the insulating medium on the end-turns using supervised machine learning with images of previously recognized or known flaws in coverage of the insulating medium.

The stator assembly may be turned via an electric motor operatively connected to a fixture configured to mount the stator assembly.

Each of the rotating arrangement and the imaging device may be arranged in-line with and integrated into the automated assembly line. Rotating of the heated stator assembly and applying thermal imaging may be performed automatically as part of a stator assembly fabrication process.

The exposed end-turns of the stator windings may include welded connections. Coating the exposed end-turns of the stator windings may include dipping the exposed heated end-turns into an epoxy.

The exposed end-turns of the stator windings may be heated to a temperature in a range of 150-170 degrees Celsius.

Turning the stator assembly may be accomplished at a speed in a range of 1-5 RPM.

A system for detecting coating defects on windings of a stator assembly for an electric motor using the method as described above is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a perspective schematic illustration of a radial flux electric motor having rotor and stator assemblies.

FIG. 2 is a schematic perspective view of the stator portion of the electric motor shown in FIG. 1, depicting stator windings end-turns coated with an insulating medium, according to the disclosure.

FIG. 3 is a schematic close-up partial perspective view of the stator shown in FIG. 2, illustrating coated stator winding end-turns with a flaw in coverage of the insulating medium on one of the end-turns, according to the disclosure.

FIG. 4 is a schematic perspective top view of an assembly line for the stator shown in FIG. 2, illustrating, incorporated into the assembly line, a system for detecting coating defects on stator winding end-turns, according to the disclosure.

FIG. 5 illustrates, in flow chart format, a method of detecting coating defects on windings of a stator assembly, as shown in FIGS. 1-4, according to the disclosure.

### DETAILED DESCRIPTION

Embodiments of the present disclosure as described herein are intended to serve as examples. Other embodiments may take various and alternative forms. Additionally, the drawings are generally schematic and not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure.

Certain terminology may be used in the following description for the purpose of reference only and thus are not intended to be limiting. For example, terms such as “above” and “below” refer to directions in the drawings to which reference is made. Terms such as “front”, “back”, “fore”, “aft”, “left”, “right”, “rear”, “side”, “upward”, “downward”, “top”, and “bottom”, etc., describe the orientation and/or location of portions of the components or elements within a consistent but arbitrary frame of reference, which is made clear by reference to the text and the associated drawings describing the components or elements under discussion.

Furthermore, terms such as “first”, “second”, “third”, and so on may be used to describe separate components. Such terminology may include the words specifically mentioned above, derivatives thereof, and words of similar import, and are used descriptively for the figures, and do not represent limitations on the scope of the disclosure, as defined by the appended claims. Moreover, the teachings may be described herein in terms of functional and/or logical block components and/or various processing steps. It should be realized that such block components may include a number of hardware, software, and/or firmware components configured to perform the specified functions.

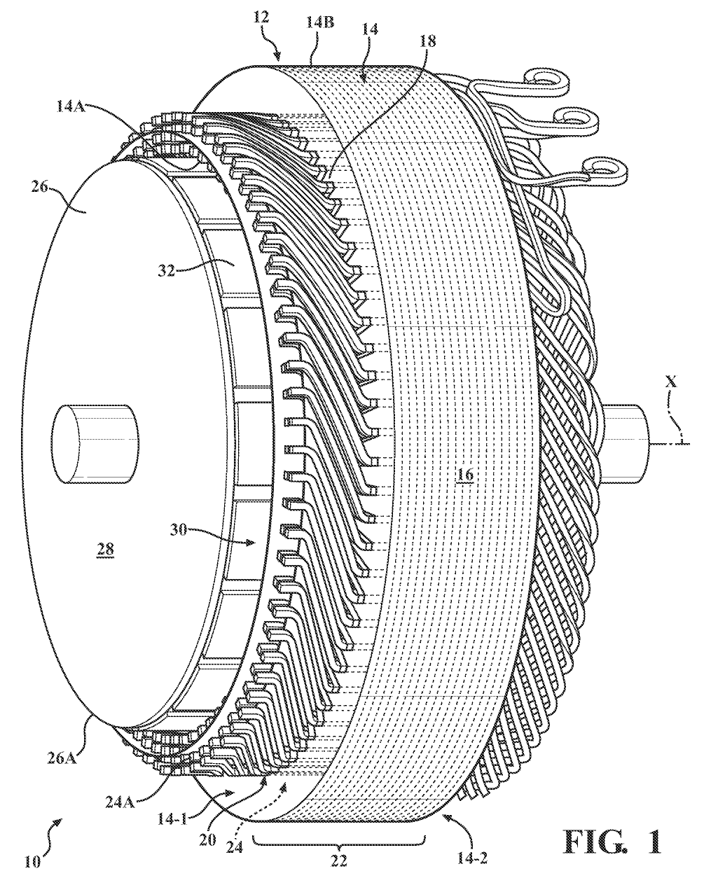

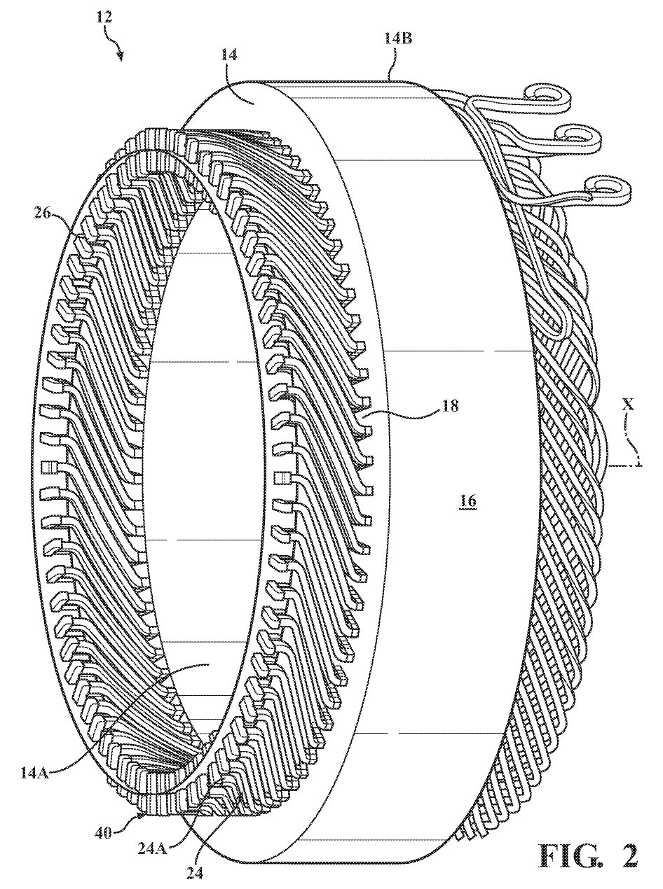

FIG. 1 illustrates a radial flux motor-generator or electric motor 10. As understood by those skilled in the art, such an electric motor 10 may be sized and packaged to operate in various applications, such as to power a motor vehicle. As shown in FIGS. 1 and 2, the motor-generator 10 includes a rotationally fixed stator assembly or stator 12 having a generally cylindrical stator core 14 defining a stator core body or back iron 16 and a plurality of stator teeth 18 extending therefrom. The stator core 14 is constructed from a ferromagnetic material and has a stator inside diameter (ID) defining a radially inner stator surface 14A and a stator outside diameter (OD) defining a radially outer stator surface 14B. The stator teeth 18 define multiple conductor slots 20 therebetween. The stator core 14 may include or be constructed from a plurality of adjacent, e.g., bonded, stator laminations 22 arranged along a stator axis X.

As shown in FIGS. 1 and 2, stator 12 also includes a plurality of insulated conductors or wire windings 24 extending through and supported by the conductor slots 20 and arranged concentrically around the stator axis X. Specifically, one or more conductors 24 may be arranged within some or each of the conductor slots 20. Although the stator conductors 24 are generally contained within the conductor slots 20, conductor ends or end-turns 24A typically extend beyond the limits of the core 14 at axially opposite core ends – a first or front end 14-1 and a second or back end 14-2 – and are thus left exposed. The end-turns 24A are typically welded once the conductors 24 are in place within the slots 20 to generate a continuous current path therethrough.

As shown in FIG. 1, the motor-generator 10 also includes a rotor 26 mounted on a rotatable shaft positioned on the stator axis X and thereby arranged for rotation inside the stator 12. The rotor 26 has an external rotor surface 26A and a ferromagnetic rotor core 28 having axially opposite rotor core ends. The rotor core 28 may be constructed from a relatively soft magnetic material, such as laminated silicon or ferrous steel. With continued reference to FIG. 1, in the radial flux motor-generator 10 the rotor core outer surface 28A establishes an airgap 30 between the rotor 26 and the stator 12, i.e., between the external rotor surface 28A and the radially inner stator surface 14A. As shown, the rotor 26 includes a plurality of magnetic poles 32, with each pole being configured to generate a magnetic flux. The stator conductors 24 receive multiphase AC from a power inverter to establish a rotating magnetic field exerting torque upon the rotor 26. Specifically, the stator conductors 24 are configured to establish the rotating magnetic field exerting a torque on the rotor 26 via interaction with the rotor’s magnetic poles 32 across the airgap 30.

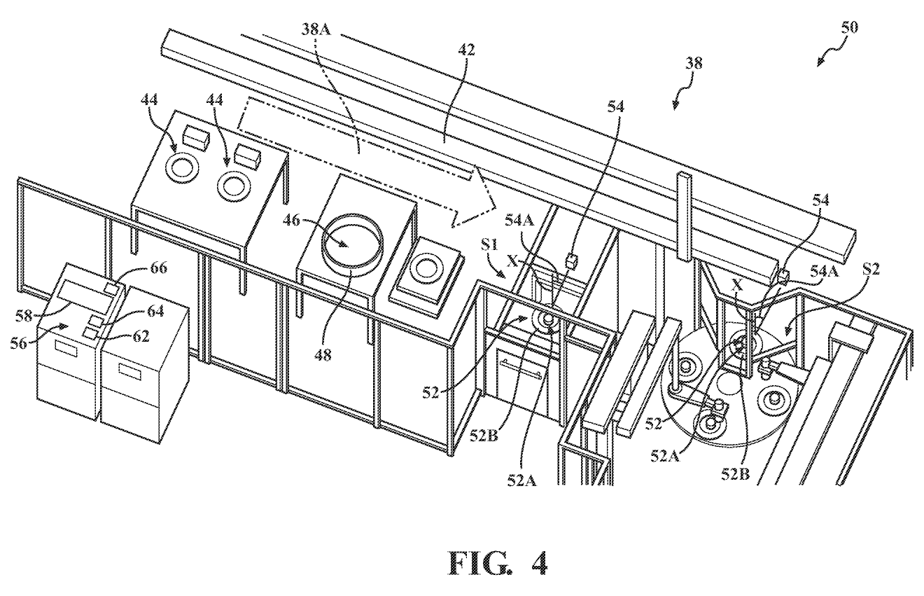

Each of the stator 12 and the rotor 26 is typically constructed via a respective assembly process and then put together to form the electric motor 10. With reference to FIG. 4, stator 12 is constructed and provided using an automated assembly line 38. As noted above, stator windings 24 are individually wrapped or insulated from one another to prevent a short circuit during operation of the electric motor 10. The stator 12 may also include a plurality of slot liners (not shown), with each slot liner arranged within a respective conductor slot 20, surrounding and protecting the stator windings 24 in the subject slot. For the welding of end-turns 24A to take place, however, the end-turns are preliminarily exposed by being stripped of their insulation. Following the welding, end-turns 24A are coated with an insulating medium 40 (shown in FIG. 1), such as an epoxy, to restore individual integrity of the stator windings 24 and electrical insulation of the end-turns 24A.

FIG. 4 indicates direction of the process flow using the assembly line 38 via numeral 38A. The assembly line 38 may also include a gantry transfer apparatus 42 for shifting stator assemblies along the process stations. As shown in FIG. 4, the assembly line 38 includes a heating arrangement 44 configured to increase the temperature of the exposed end-turns 24A of the stator windings. The entire stator assembly 12 may be heated or specifically the welded stator winding end-turns 24A to promote adhesion of the insulating medium 40. The heating arrangement 44 may include an induction coil targeting the exposed end-turns 24A or an oven to house the entire stator assembly 12. The temperature of the end-turns 24A may be increased via the heating arrangement 44 into a range of 150-170 degrees Celsius. The assembly line 38 also includes a coating arrangement 46 for covering or coating the exposed heated end-turns 24A with the insulating medium 40, such as by dipping the heated end-turns into a container 48 with an epoxy or powder coating the heated end-turns (not shown).

The assembly line 38 is part of a system 50 (indicated in FIG. 4) for detecting coating defects or flaws on the stator assembly windings 24. The system 50 also includes a rotating arrangement 52 configured to turn the stator assembly 12 with the coated heated end-turns 24A relative to the stator axis X. The rotating arrangement 52 may include an electric motor 52A operatively connected to a fixture 52B which is configured to mount the stator assembly 12. The electric motor 52A may be configured to rotate the fixture 52B with the mounted stator assembly 12 at a speed in a range of 1-5 revolutions per minute (RPM). The rotating arrangement 52 may be positioned in a number of alternative locations in the process flow (as indicated by two exemplary positions, one at a quality inspection drawer S1, directly following the coating arrangement 46, and another at an unload station S2 proximate the end of the assembly line 38). The assembly line 38 also includes an imaging device 54 configured to apply thermal imaging to the coated heated end-turns 24A of the turning stator assembly 12. The imaging device 54, such as an infrared camera, may be arranged on or proximate the assembly line 38 (for example, either at station S1 or S2), at a predefined angle 54A (for example in a range of 10-30 degrees) relative to the stator axis X.

Generally, infrared thermal imaging uses camera(s) to detect infrared radiation via lenses that focus on heat waves emitted by objects. Camera sensors convert the heat waves into electrical signals. The camera's software processes the electrical signals to create and display a thermal image or thermogram. Typically, warmer objects in a thermogram appear in red, orange, or yellow, while cooler objects appear in blue, purple, or green. As will be described below, the generated thermogram may then be used to identify defects, such as bare spots, in the insulating medium 40 coverage of the coated end-turns 24A. As shown in FIG. 4, each of the rotating arrangement 52 and the imaging device 54 may be arranged in-line with and integrated into the automated assembly line 38 and is configured to respectively rotate the stator assembly 12 and apply thermal imaging automatically as part of a stator assembly fabrication process.

With continued reference to FIG. 4, system 50 additionally includes an electronic controller 56 in operative communication with the imaging device 54. The electronic controller 56 may be configured to communicate with external or remote, such as cloud-based, data storage. The electronic controller 56 includes a memory that is tangible and non-transitory. The memory may be a recordable medium that participates in providing computer-readable data or process instructions. Such a medium may take many forms, including but not limited to non-volatile media and volatile media. Non-volatile media used by the controller 56 may include, for example, optical or magnetic disks and other persistent memory. The controller 56 also includes algorithms that may be implemented as electronic circuits, e.g., FPGA, or as algorithms saved to non-volatile memory.

Volatile media of the controller 56 memory may include, for example, dynamic random-access memory (DRAM), which may constitute a main memory. Memory of the controller 56 may also include a flexible disk, hard disk, magnetic tape, other magnetic medium, a CD-ROM, DVD, other optical medium, etc. The controller 56 may be equipped with a high-speed primary clock, requisite Analog-to-Digital (A/D) and/or Digital-to-Analog (D/A) circuitry, input/output circuitry and devices (I/O), as well as appropriate signal conditioning and/or buffer circuitry. Algorithms required by controller 56 or accessible thereby may be stored in the controller memory and automatically executed to provide the required functionality. The controller 56 may be configured, i.e., structured and programmed, to receive and process captured raw data signals (thermal images) gathered by the imaging device 54. The controller 56 may be additionally configured to display the generated thermogram on a visual monitor 58 for assessment by an assembly line attendant.

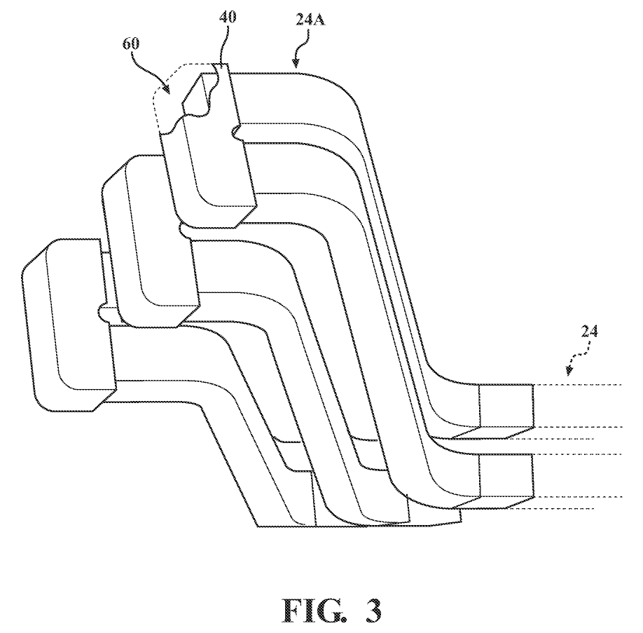

The electronic controller 56 employs one or more algorithms to identify flaw(s) 60 (shown in FIG. 3), such as bare spots, in coverage of the insulating medium 40 on the corresponding coated end-turns 24A using data captured by the imaging device 54. For example, with thermal imaging, a bare spot on the coated end-turns 24A would be warmer and appear in the generated thermogram in red, orange, or yellow, thereby contrasting with cooler fully coated end-turns, which would appear in blue, purple, or green. The electronic controller 56 is additionally configured to command a rejection of the stator assembly 12 having the identified flaw(s) 60 on corresponding coated end-turns 24A. The electronic controller 56 may be programmed to reject the stator assembly 12 having the identified flaw(s) 60, such as by triggering a sensory signal 62, e.g., an audible alarm, and/or an automatic ejection 64 of the faulty stator from the automated assembly line 38.

The electronic controller 56 may be programmed with an artificial intelligence (AI) algorithm 66 configured to identify one or more flaws in coverage of the insulating medium 40 on the end-turns 24A. Specifically, the AI algorithm 66 may be configured to use thermal image processing to recognize flaws on the coated end-turns 24A. The AI algorithm 66 may be trained to recognize or identify flaws in coverage of the insulating medium 40 on the end-turns 24A using supervised machine learning (ML) with thermal images of previously identified or recognized (labeled) end-turn coverage defects. Such images of recognized or known end-turn defects may be collected from previously inspected, e.g., manually, and identified stator assemblies 12 and collected in a training image database for access by the AI algorithm 66.

Generally, ML is a type of AI that allows machines to learn and improve their performance over time. ML algorithms are trained using data sets that are labeled with the desired output. The ML algorithms learn to map the input data to the output data. Once trained, the algorithms may use the mapping to predict outputs for new data e.g., analyze images and identify patterns to help with diagnosis. ML algorithms typically identify image features by calculating the most important features of an image, identify the best combination of features to classify the image, and predict an outcome by identifying the best solution or match. In the case of system 50, the ML trained AI algorithm 66 may be used to process thermal images of a turning stator assembly 12 with heated end-turns 24A to identify flaws 60 in coverage of the insulating medium 40 thereon.

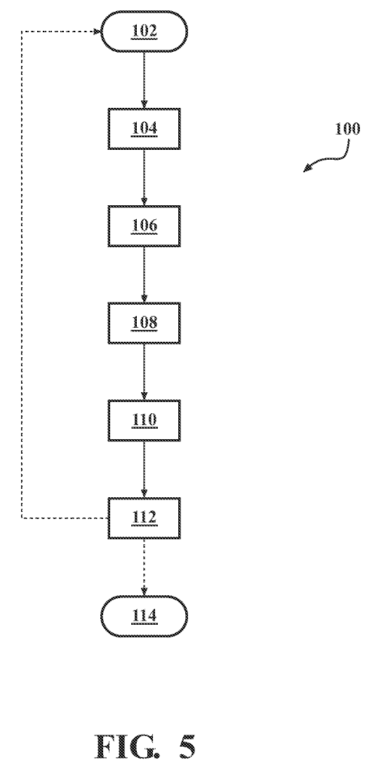

A method 100 of detecting coating defects on windings of a stator assembly 12 for an electric motor 10 is shown in FIG. 5 and described below with reference to the system 50 and structure shown in FIGS. 1-4. Method 100 commences in frame 102 with providing, via the automated assembly line 38, the stator assembly 12 having stator windings 24 with exposed end-turns 24A arranged around the stator axis X. As described above with respect to FIGS. 1-4, the end-turns 24A may be exposed by assembly process in order to have them welded to generate continuous stator windings 24. From frame 102, the method advances to frame 104. In frame 104, the method includes heating the exposed end-turns 24A of the stator windings via the heating arrangement 44. As noted, the heating arrangement 44 may include an induction coil or an oven to heat the exposed end-turns 24A.

Following frame 104, the method advances to frame 106. In frame 106, the method includes coating the exposed heated end-turns 24A with the insulating medium 40 via the coating arrangement 46. Specifically, the coating of the exposed heated end-turns 24A may be accomplished by dipping the end-turns into epoxy or powder coating the stator winding ends. After frame 106, the method moves on to frame 108. According to the disclosure, in frame 108, the method includes turning the stator assembly 12 with the coated heated end-turns 24A relative to the stator axis X via the rotating arrangement 46. As described above with respect to FIGS. 1-4, the rotating arrangement 52 may include the electric motor 52A operatively connected to the fixture 52B configured to mount the stator assembly 12. After frame 106, the method proceeds to frame 108.

In frame 108, the method specifically includes applying thermal imaging, via the imaging device 54 in operative communication with the electronic controller 56, to the coated heated end-turns 24A of the turning stator assembly 12. As described above, the imaging device 54 may be an infrared camera arranged at the predefined angle 54A relative to the stator axis X. Following frame 108, the method may advance to frame 110. In frame 110, the method includes identifying, via the electronic controller 56, flaw(s) 60 in coverage of the insulating medium 40 on the coated end-turns 24A using the applied thermal imaging. After frame 110, the method proceeds to frame 112. In frame 112, the method includes commanding, via the electronic controller 56, a rejection of the stator assembly 12 having the identified flaw(s) 60 in coverage of the insulating medium 40 on the corresponding coated end-turns 24A. The rejection of the stator assembly 12 having the identified flaw(s) 60 may be affected by triggering a sensory signal 62, such as an audible alarm, and/or an automatic ejection 64 of the subject faulty stator from the automated assembly line 38.

As described above with respect to FIGS. 1-4, the electronic controller 56 may be programmed with the AI algorithm 66 configured to identify the flaw(s) 60 in coverage of the insulating medium 40 on the end-turns 24A. The AI algorithm 64 may be configured to use image processing to recognize flaws in coverage of the insulating medium 40 on end-turns 24A. The AI algorithm 66 may be specifically trained to recognize flaws in coverage of the insulating medium 40 using supervised machine learning with images of previously recognized flaws in coverage of the insulating medium. Following frame 112, the method may return to frame 102 for inspection of another stator assembly 12 or conclude in frame 114. Overall, method 100 is intended to inspect stator assemblies 12 as part of an automated assembly process for detecting coating defects on stator windings 24.

The method 100 may also be employed to identify flaws in coverage of insulating medium on the windings 24 outside the exposed end-turns 24A. For example, the automated assembly line 38 may receive the stator assembly 12 with winding areas, other than the end-turns 24A, precoated with an insulating material. However, prior handling of stator 12 may leave gaps or flaws in the insulation. Thermal imaging may also be applied to those precoated areas of the windings 24 to identify potential flaws. The electronic controller 56 may be suitably programmed to analyze such areas of the windings 24, including with the AI algorithm 66 described above. The imaging device 54 may then be arranged at a modified angle 54A relative to the stator axis X and/or the stator 12 may be rotated not only relative to the stator axis but also turned end-over-end, between the front and back ends 14-1, 14-2 of the core, to arrange such precoated areas within the camera view and permit their analysis.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A method of detecting coating defects on windings of a stator assembly for an electric motor, the method comprising:
providing, via an automated assembly line, the stator assembly having a plurality of stator windings with exposed end-turns arranged around a stator axis;
heating the exposed end-turns of the stator windings via a heating arrangement;
coating the exposed heated end-turns with an insulating medium;
turning the stator assembly with the coated heated end-turns relative to the stator axis via a rotating arrangement;
applying thermal imaging, via an imaging device in operative communication with an electronic controller, to the coated heated end-turns of the turning stator assembly;
identifying, via the electronic controller, a flaw in coverage of the insulating medium on the coated end-turns using the applied thermal imaging; and
commanding, via the electronic controller, a rejection of the stator assembly having the identified flaw in coverage of the insulating medium on the corresponding coated end-turns.

2. The method according to claim 1, wherein applying thermal imaging includes using an infrared camera.

3. The method according to claim 2, wherein the infrared camera is arranged at a predefined angle relative to the stator axis.

4. The method according to claim 1, wherein the electronic controller is programmed with an artificial intelligence (AI) algorithm configured to identify the flaw in coverage of the insulating medium on the end-turns.

5. The method according to claim 4, wherein the AI algorithm is configured to use image processing to recognize flaws in coverage of the insulating medium on the end-turns.

6. The method according to claim 5, wherein the AI algorithm is trained to recognize flaws in coverage of the insulating medium on the end-turns using supervised machine learning with images of previously recognized flaws in coverage of the insulating medium.

7. The method according to claim 1, wherein turning the stator assembly is accomplished via an electric motor operatively connected to a fixture configured to mount the stator assembly.

8. The method according to claim 1, wherein each of the rotating arrangement and the imaging device is arranged in-line with and integrated into the automated assembly line, and wherein each of rotating the stator assembly and applying thermal imaging is performed automatically as part of a stator assembly fabrication process.

9. The method according to claim 1, wherein coating the exposed end-turns of the stator windings includes dipping the exposed heated end-turns into an epoxy.

10. The method according to claim 1, wherein:
heating the exposed end-turns of the stator windings is accomplished in temperature range of 150-170 degrees Celsius; and
turning the stator assembly is accomplished at a speed in a range of 1-5 revolutions per minute (RPM).

11. A system for detecting coating defects on windings of a stator assembly for an electric motor, the system comprising:
an automated assembly line configured to provide the stator assembly, wherein the stator assembly includes a plurality of stator windings with exposed end-turns arranged around a stator axis;
a heating arrangement configured to heat the exposed end-turns of the stator windings;
an arrangement for coating the exposed heated end-turns of the stator windings with an insulating medium;
a rotating arrangement configured to turn the stator assembly with the coated heated end-turns relative to the stator axis;
an imaging device configured to apply thermal imaging to the coated heated end-turns of the turning stator assembly; and
an electronic controller in operative communication with the imaging device and configured to:
identify a flaw in coverage of the insulating medium on the corresponding coated end-turns using the applied thermal imaging; and
command a rejection of the stator assembly having the identified flaw in coverage of the insulating medium on the coated end-turns.

12. The system according to claim 11, wherein the imaging device is an infrared camera.

13. The system according to claim 12, wherein the infrared camera is arranged at a predefined angle relative to the stator axis.

14. The system according to claim 11, wherein the electronic controller is programmed with an artificial intelligence (AI) algorithm configured to identify the flaw in coverage of the insulating medium on the end-turns.

15. The system according to claim 14, wherein the AI algorithm is configured to use thermal image processing to recognize flaws in coverage of the insulating medium on the end-turns.

16. The system according to claim 15, wherein the AI algorithm is trained to recognize flaws in coverage of the insulating medium on the end-turns using supervised machine learning with images of previously recognized flaws in coverage of the insulating medium.

17. The system according to claim 11, wherein the rotating arrangement includes an electric motor operatively connected to a fixture configured to mount the stator assembly.

18. The system according to claim 11, wherein each of the rotating arrangement and the imaging device is arranged in-line with and integrated into the automated assembly line and is configured to respectively rotate the stator assembly and apply thermal imaging automatically as part of a stator assembly fabrication process.

19. The system according to claim 11, wherein the arrangement for coating exposed ends of the stator windings includes a container with epoxy for dipping the exposed heated end-turns therein.

20. A method of detecting coating defects on windings of a stator assembly for an electric motor, the method comprising:
providing, via an automated assembly line, the stator assembly having a plurality of stator windings with exposed end-turns arranged around a stator axis;
heating the exposed end-turns of the stator windings via a heating arrangement;
coating the exposed heated end-turns with an insulating medium;
turning the stator assembly with the coated heated end-turns relative to the stator axis via a rotating arrangement;
applying thermal imaging, via an imaging device in operative communication with an electronic controller, to the coated heated end-turns of the turning stator assembly;
identifying, via the electronic controller, a flaw in coverage of the insulating medium on the coated end-turns using the applied thermal imaging; and
commanding, via the electronic controller, a rejection of the stator assembly having the identified flaw in coverage of the insulating medium on the corresponding coated end-turns;
wherein:
the electronic controller is programmed with an artificial intelligence (AI) algorithm configured to identify the flaw in coverage of the insulating medium on the end-turns; and
the AI algorithm is configured to use image processing to recognize flaws in coverage of the insulating medium on the end-turns and is trained to recognize flaws in coverage of the insulating medium on the end-turns using supervised machine learning with images of previously recognized flaws in coverage of the insulating medium.
